(19) United States
(12) Patent Application Publication
(10) Pub. No.: US 2016/0029465 A1
(43) Pub. Date: Jan. 28, 2016

(54) SYSTEM AND METHOD FOR ELECTRONIC DEVICE CONTROL IN THE PRESENCE OF ELECTRICAL ARCING

(71) Applicant: KONINKLIJKE PHILIPS N.V., Eindhoven (NL)

(72) Inventors: ARINDAM CHAKRABORTY, CHICAGO, IL (US); ARUN GANESH, AURORA, IL (US); ZHIHUA SONG, SHANGHAI (CN); PAUL ROBERT VELDMAN, EINDHOVEN (NL); GUANGYI LUO, SHANGHAI (CN)

(73) Assignee: Koninklijke Philips N.V., Eindhoven (NL)

(21) Appl. No.: 14/782,814

(22) PCT Filed: Apr. 2, 2014
(86) PCT No.: PCT/IB2014/060368

§ 371 Date: Oct. 7, 2015

Related U.S. Application Data
(60) Provisional application No. 61/811,416, filed on Apr. 12, 2013.

(51) Int. Cl. H05B 41/285; H05B 41/38

(52) U.S. Cl. CPC H05B 41/2855; H05B 41/38

(57) ABSTRACT

This invention discloses a method and apparatus managing a voltage applied to a load. The method comprises determining generation of an electrical arc, the electrical arc being determined based on detecting a high frequency signal; isolating and filtering the high frequency arc signal; generating a signal having a frequency proportional to the frequency of the arc signal; and altering a frequency of the voltage applied to the load in response to the frequency of the signal.

This application is related to the field of electronic circuits and more particularly to a system and method for controlling electronic devices in response to the detected electrical arcing.

Electrical arc detection and control is an essential part of ballast/driver operation for the purpose of safety and security, especially in certain applications such as refrigeration, closed cabinet & furniture, etc. This protection feature, officially known as Type CC circuit, can generate a response in the detection device at the instant of an arc occurrence at a socket.

Electrical output arcing between the lamp holders and the lamp pins is a common phenomenon observed in most fluorescent ballasts. It is a common practice to change the damaged lamps on an active (i.e., electrically powered) ballast. This method is known as ‘hot-relamping’. During the process of ‘hot-relamping’, when a lamp is being removed, or reinserted, a momentary arc situation can be observed that can be prolonged, if not quenched immediately. This prolonged or sustained arc happens due to improper sitting of the lamps in the lamp holders or in a gap created between the lamp pins and the pin holder sockets. This high intensity electrical arcing, produced in the air gaps, due the improper placement and connection of the lamp pins in the socket can cause serious degradation and, hence, permanent damage to the lamp pin holders by producing electric flashing and smoke. This arcing, in addition, can be dangerous for the personnel working on changing the lamps in the active ballast.

In one conventional method, electrical arcing control for electronic ballast comprises a complete shutdown of the ballast when an arc occurs during, for example, lamp removal. The ballast then restarts when the arc is completely removed. See for example, WO 2006016334, entitled “Apparatus and Method for Eliminating Electric Arc,” filed on Feb. 16, 2006, which is assigned to Koninklijke Philips Electronics NV, the assignee of the instant application, the contents of which are incorporated, herein, by reference.

However, causing a complete shutdown of the ballast to achieve arc control results in two additional problems: longer response time to re-activate the lamp after the arc is quenched and a hiccup mode, wherein the device may not fully re-activate.

Another conventional method to address the arcing problem is to lower the open circuit voltage (OCV) of the ballast/driver. However, this method does not work reliably for high light-output (lamp current >300 mA) drivers. That is, the lamp arc level remains high enough so as to not meet a Type CC requirement. Another disadvantage of lowering the OCV is that sometimes lamps do not automatically restart when a failed lamp is replaced in the field, without recycling the input power to the ballast/driver.

In addition, during the operation of a Tubular LED (TLED) lamp in conjunction with an electronic fluorescent driver, there is often a problem of mis-use by the operating personnel at the lamp ends. This is caused in a regular ballast, without any lamp current control or closed loop control, when one end of the lamp remains connected to the holder and the other end is disconnected or exposed, which by mistake if touched by a personnel will cause shock hazards.

Hence, there is a need in the industry for methods and systems for detecting electrical arcing and responsive to the detected arc controlling electronic devices in a manner to provide faster re-activation time, insure re-activation without hiccupping, extend an operation life of an electronic element and avoid injury to personal.

It is an object of the present invention to provide methods and systems for overcoming problems caused by a complete shutdown of the ballast by not allowing the ballast to shut-down completely and restart by providing appropriate control of the current fed to the current-control pin of the ballast.

It is an object of the present invention to provide for a method and system for avoiding false triggering or flashing of lamps that are not seated well.

It is an object of the present invention to provide a method and system for avoiding short lamp-life that can occur if flashing of the lamps is allowed to continue.

It is an object the present invention to provide a control scheme to regulate the load current and load power at the output circuit at the instant of an ‘arc phenomenon.’

A current control method, in accordance with the principles of the invention is to restrict the ballast from incurring a complete shut-down and, hence, can recover at a fast response rate without introducing a hiccup mode, which otherwise would have happened if the ballast is allowed to shut-down completely. The method described herein also helps to avoid false triggering or flashing of lamps that are not seated well. In addition, this approach can lead to avoid short lamp-life that can occur if flashing of the lamps is allowed to continue as it happens in the current solution. Another advantage of this scheme is that it comes to play only during arc detection and, hence, does not reduce the efficiency of the ballast lamp system during normal operation.

In accordance with the principles of the invention, a method for managing a voltage applied to a load is disclosed. The method comprising determining generation of an electrical arc, said arc being determined based on detecting a high frequency signal; isolating and filtering said high frequency signal; generating a signal having a frequency proportional to said filtered high frequency signal; and altering a frequency of a voltage in response to said signal, wherein alteration of said frequency of said voltage is a function of the frequency of the signal.

In another aspect of the invention, protection circuit is disclosed. The protection circuit comprises a first converter converting received input AC signal to a DC signal; a second converter converting said DC signal to an AC output signal at a desired frequency; a feedback circuit providing a signal to the second converter, the signal having a frequency proportional to a frequency of the detected arc signal, wherein the signal when applied to said second converter causes the frequency of a voltage associated the AC output signal to be increased.

In another aspect of the invention, a circuit for managing voltage applied to a load in view of detection of an electrical arc is disclosed. The circuit comprises a detection circuit: receiving a signal from the load; detecting the arc within the signal, and generating an arc detect signal in response to the detected arc; a processing circuit:

receiving the arc detect signal generated in response to the detected arc; generating a second signal proportional to a frequency of the arc detect signal; an output circuit; receiving the second signal; and altering a frequency of the voltage applied to the load in response to the second signal causing a corresponding current applied to the load to decrease.

The advantages, nature, and various additional features of the invention will appear more fully upon consideration of the illustrative embodiments to be described in detail in connection with the accompanying drawings wherein like reference numerals are used to identify like elements throughout the drawings:

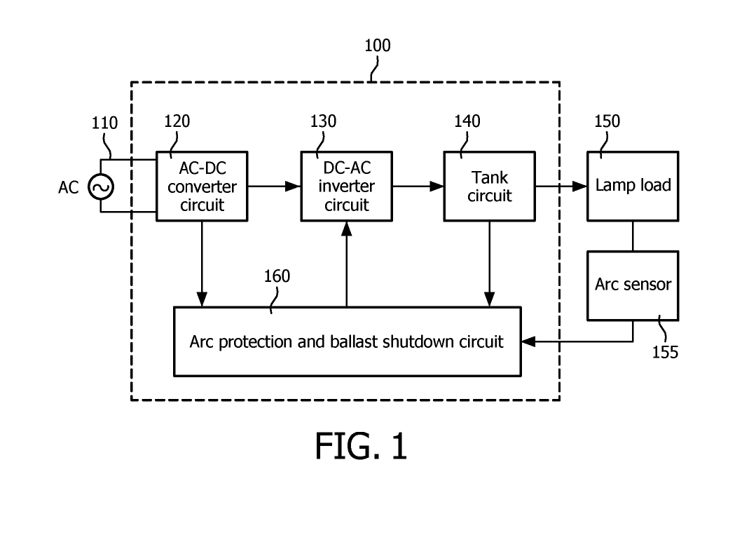

FIG. 1 illustrates a conventional control circuit;

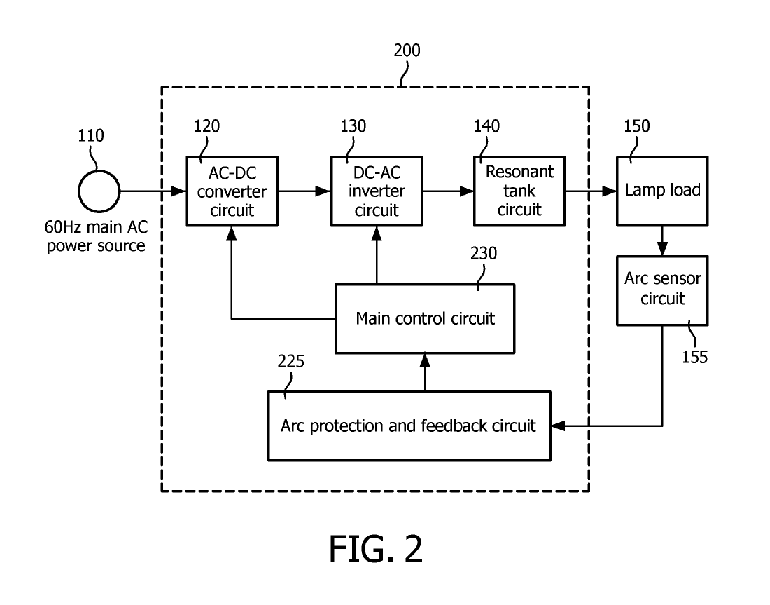

FIG. 2 illustrates a control circuit in accordance with the principles of the invention;

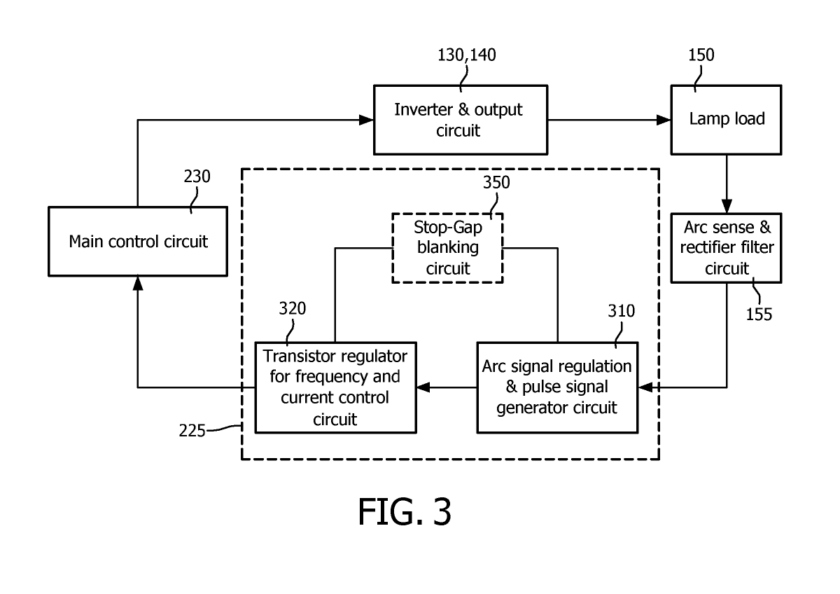

FIG. 3 illustrates a second aspect of the control circuit shown in FIG. 2;

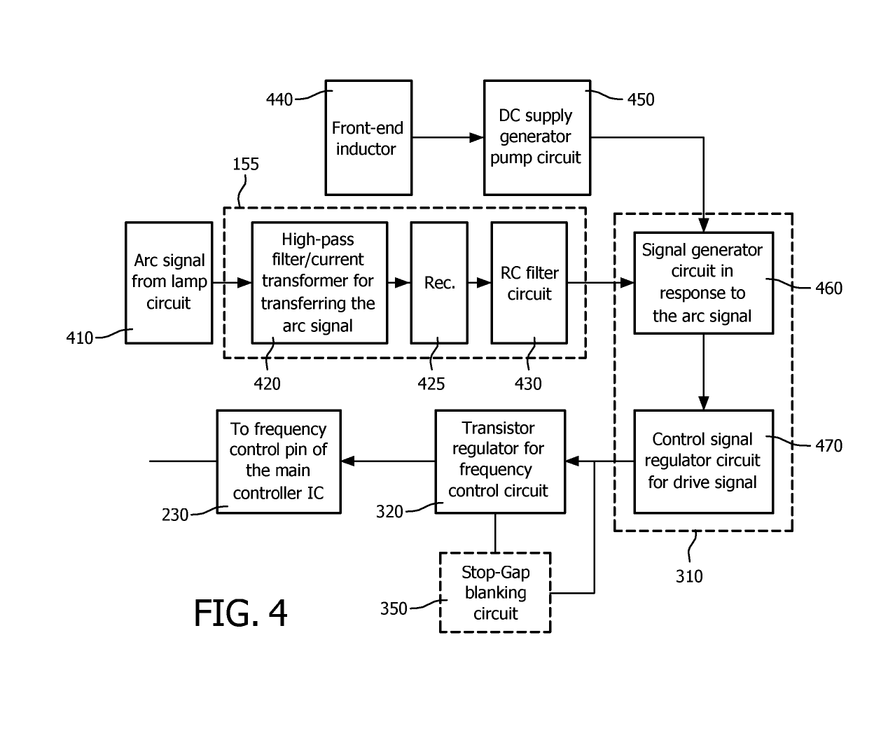

FIG. 4 illustrates a further detailed aspect of the control circuit shown in FIG. 2; and

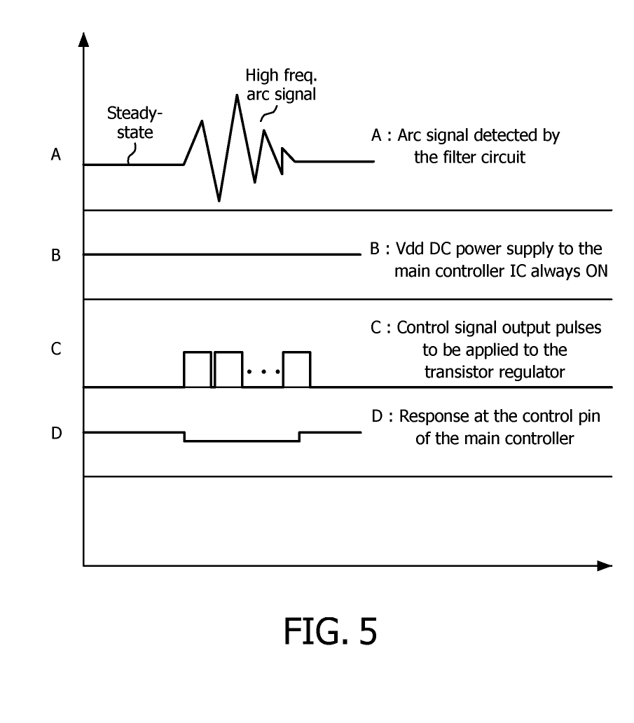

FIGS. 5A-5D illustrate an exemplary voltage and frequency charts in accordance with the operation of the control circuit shown herein.

It is to be understood that the figures and descriptions of the present invention described herein have been simplified to illustrate the elements that are relevant for a clear understanding of the present invention, while eliminating, for purposes of clarity only, many other elements. However, because these eliminated elements are well-known in the art, and because they do not facilitate a better understanding of the present invention, a discussion of such elements or the depiction of such elements is not provided herein. The disclosure herein is directed also to variations and modifications known to those skilled in the art.

FIG. 1 illustrates a conventional control circuit for controlling electronic devices when arcing is detected, wherein a typical network of arc control will either permanently shut down the ballast, or will be shut down for a period of time and then we started, when an arc is detected.

Referring to FIG. 1, there is shown an electrical source 110 providing a voltage from Alternating Current (AC) source (hereinafter referred to an AC voltage) to protection circuit 100, which provides a voltage to a load 150. Protection circuit 100 receives the inputted AC voltage from source 110 and converts the inputted AC voltage to a DC (Direct Current) voltage in AC-DC converter circuit 120. The DC voltage is then applied to a DC-AC inverter circuit 130 which provides reconstructed AC voltage of a desired frequency to a tank circuit 140. The output of tank circuit 140 is then applied to load 150.

Also shown is Arc Protection circuit and shutdown circuit 160, which receives inputs from AC-DC converter circuit 120, output tank circuit 140 and arc sensor 155. Arc Protection circuit and shutdown circuit 160 provides an output to inverter 130 to control the input to the output circuit 140 when an arc is detected by arc sensor 155.

Arc protection circuit and shutdown circuit 160 inhibits the inverter circuit 130 from providing an input signal to tank circuit 140 when an electrical arc is detected by arc sensor 155.

FIG. 2 illustrates a block diagram of an arc protection control circuit 200 for controlling electronic devices in accordance with the principles of the invention. In this illustrated example, an AC voltage is provided to arc protection circuit 200, as previously described. The provided AC voltage is subsequently provided to load 150 through tank circuit 140 as previously described.

Arc protection circuit 200 comprises an AC-DC converter 120 receiving the input AC voltage from source 110. When an input power, provided by an electrical source (referred to as mains) is applied at a nominal 60 Hz input frequency (or a 50 Hz input frequency), AC/DC converter circuit 120 converts the input AC voltage to a regulated DC signal or voltage. In one aspect of the invention, a main driver integrated circuit (IC) (not shown) is used. The main driver IC is operable as a universal input converter that may be responsive to varying voltage inputs (e.g., 120V, 240V, 277V, etc.).

The regulated DC voltage of AC/DC converter 120 is then applied to a DC/AC inverter circuit (e.g., half bridge inverter circuit) 130. The DC/AC inverter circuit 130 is an alternately switched to generate a modulated signal that is applied to resonant tank circuit 140.

The output of tank circuit 140 is provided to load 150. The load 150 may include a lamp ballast (not shown). May further be connected to an arc detector 155, in a manner similar to the circuit shown in FIG. 1.

Although in this illustrated example, the load 150 is a lamp load, it would be understood that the load 150 may be other types of loads (e.g., different types of lamp loads with various wattages). In addition, the load 150 may be an electronic device that requires protection in the presence of an arc. Thus, the device described, herein, may be generally described with regard to arc protection circuitry.

Arc sensing device 155 is a high frequency sensing circuit that is connected in series with load 150. Arc sensing circuit 155 operates as a filter in which a nominal steady state signal will be blocked and a high frequency arc signal is allowed to pass through. The high frequency arc signal that passes through arc sensing device 155 is then provided to and operated on by arc protection circuit 225. The output of arc sense circuit 155 may alternately be one of a trigger signal, such as a one-shot, or a change in voltage level.

The arc protection device 225 receiving a signal from arc sensing device 155 then drives a feedback control circuit (not shown) in main control circuit 230 that generates a proportional feedback response of the current loop of the main control circuit 230. This feedback control signal causes the main control circuit 230 to adjust the current fed to load (i.e., load current) 150. As a result of the adjustment to the current fed to load 150 (through inverter circuit 130), the frequency of the output tank circuit 140 increases and, hence, controls the current at the output.

In another aspect of the invention, an initial stop-gap/blanking circuit (not shown) restricts the arc protection circuit 155 from being activated during a normal ignition mode or when the inverter 130 is started during a main switch power-on process. As the arc sensing circuit 155 is sensitive to a signal generated only by arcing, which may be represented as high frequency impulses superimposed on normal output current waveform, during a first instance of load turn on, this stop-gap/blanking circuit (see FIG. 3) guarantees a normal start of the lamps by restricting any kind of false triggering cause by turn on spikes.

In accordance with the principles of the invention, during the period of lamp removal or reinsertion is performed, a gap created between a lamp socket and a lamp pin may trigger a high frequency arc signal. This high frequency arc signal is sensed by the arc sensing circuit 155 and a proportional trigger signal is then generated in the feedback control loop 225 for generating a proportional control signal for the main control circuit 230. This proportional trigger signal operates as a control signal entering the control element of the main control circuit 230 that will mitigate the effects of the sensed arc by alternating the current provided to the load 150.

More specifically, the control signal adjusts a voltage level on a charging capacitor (not shown) across a control pin of the main controller 230 and, hence, increases an output frequency of the output signal so as to lower the output current to the load circuit 150 to prevent the lamp circuit 150 from going into an unstable state caused by the arcing phenomenon.

FIGS. 3 and 4, illustrate in further details the proposed system for controlling electronic loads in the presence of electrical arcing, in accordance with the principles of the invention.

In the exemplary circuits shown in FIGS. 3 and 4, the arc sense circuit 155 is composed of a high frequency arc signal pass circuit through a current transformer (420, see FIG. 4) connected in a common path with the electronic load 150.

The combination of a high frequency signal pass circuit and current transformer helps to detect arcs (or arcing) generated when the load 150 is removed or reinserted while power is applied to the load 150 (i.e., arc signal from lamp circuit 410). The high frequency arc pass transformer 420 is followed by rectification network 425 to generate an equivalent DC signal as a representation of the detected arc signal. This equivalent DC signal is filtered by a Resistor-Capacitor (R-C) filter circuit (430, FIG. 4) with a known decay period. As would be recognized, the R-C filter characteristics (e.g., decay period) may be determined based on the values of the resistor(s) and capacitor(s) elements within the filter.

The R-C filtered signal is applied to a signal regulation and pulse signal generator circuit 310 within arc protection circuit 225 (see FIG. 3). The output of the arc signal regulation circuit 310 is applied to a transistor regulation circuit 320 that provides a proportional control signal to main control circuit 230. The main control circuit 230 uses the proportional control signal to control the frequency response of inverter circuit 130 and a subsequent output frequency of the voltage provided to the load circuit 150.

Referring to FIG. 4, an internal power supply, 440 derived from a secondary winding of a front-end inductor (not shown) generates a signal to activate pulse signal generator circuit 460. A charge pump control circuit 450 is used to generate sufficient signal to drive the arc protection circuit 200. This internal power generator supplies steady state DC voltage to the arc protection unit 200.

The pulse signal generator circuit 470 provides a sufficiently strong pulse signal to a transistor regulator circuit 320. This transistor regulator circuit adjusts a current flowing into the current-control pin of the main controller 230. The control of the current flowing in or out of the control pin of the main controller 230 causes the voltage across the capacitor of the control pin to change. This change of the control voltage across the capacitor causes a change in the switching frequency of the inverter switching circuit. This change in the inverter switching circuit frequency results in a change in the output frequency of voltage applied to the lamp load 150 during the presence of the arc signal. As a result, the frequency of operation at the load 150 is increased to control the load current within a reliable range.

As previously described, a stop-gap/blanking circuit 350 may be connected in series with the pulse generator circuit, 460. The stop-gap/blanking circuit 350 provides a stop band to the arc protection circuit 200 being active at the instant of load initialization or start up. The stop-gap circuit 350 insures that the load has a normal start when power is first applied to the load when the mains are turned on.

FIGS. 5A-5D illustrate an exemplary voltage/frequency chart in accordance with the principles of the invention. As shown in FIG. 5A, a steady state signal is received by the arc detection circuit 155 when the lamp is operating normally. In the process of hot re-lamping, for example, a high frequency arc spike is generated and detected. FIG.

5B illustrates a DC voltage applied to the main controller which remains high all the time. That is, the main controller 230 is never turned off. FIG. 5C illustrates a plurality of control pulses that direct the main controller 230 in response to the detected arc signal of 5A. In this illustrative example, a frequency of the control pulses is proportional to a frequency of the detected arc spike. FIG. 5D illustrates the response at a control pin of the main controller 230 in response to the frequency of the control pulse signal shown in FIG. 5C. The control pulse signal is applied to transistor regulator circuit 320. In this case, during the time period of arc detection, when the high frequency arc signal is detected, the frequency of the control pulses increases in proportion to the magnitude (or frequency) of the detected arc signal. The increased frequency of the control pulses causes the inverter 130 to alter the output frequency of the voltage applied to the load 150. Thus, the current applied to the load is decreased as:

i=v/zf

wherein i is the output current;
v is the output voltage:
z is the impendence of a non-resistive load: and
f is the frequency of the output voltage
   Thus, as the frequency of the AC voltage increases, the output current decreases.

After the arc is no longer present, the frequency of the control pulses returns to a nominal value and the switching frequency of the inverter 130 returns to a corresponding nominal value.

Although the voltage is shown as a steady value (implying a DC voltage), it would be understood by those skilled in the art, that the illustrated voltage is an AC voltage level with a known frequency (i.e., 50 Hz for European electrical systems, 60 Hz for US electrical systems), which is not illustrated. Thus, in US type electrical systems, the nominal voltage is 120 volts over a single frequency cycle. When an arc is detected, the frequency of the AC voltage signal is increased; hence, the output current decreases.

The decreased current during the arc detection period or interval prevents a total shutdown of the main controller and allows the voltage to the load 150 to return to a nominal value quickly after the arc is no longer present.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer(s), or a special processor(s) or in programmable or dedicated hardware(s), such as an ASIC or FPGA. As would be understood in the art, the computer(s), the processor(s), microprocessor controller(s) or the programmable hardware(s) include memory components, e.g., RAM, ROM, Flash, etc. that may store or receive software or computer code that when accessed and executed by the computer(s), processor(s) or hardware(s) implement the processing methods described herein. A computer program may be stored/distributed on a suitable medium, such as an optical storage medium or a solid-state medium supplied together with or as part of other hardware, but may also be distributed in other forms, such as via the Internet or other wired or wireless telecommunication systems. In addition, it would be recognized that when a general purpose computer(s) accesses code for implementing the processing shown herein, the execution of the code transforms the general purpose computer(s) into a special purpose computer(s) for executing the processing shown herein.

A computer program may be stored/distributed on a suitable medium, such as an optical storage medium or a solid-state medium supplied together with or as part of other hardware, but may also be distributed in other forms, such as via the Internet or other wired or wireless telecommunication systems.

The terms “a” or “an” as used herein are to describe elements and components of the invention. This is done merely for convenience and to give a general sense of the invention. The description herein should be read to include one or at least one and the singular also includes the plural unless indicated to the contrary.

The term “comprises”, “comprising”, “includes”, “including”, “as”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “or” refers to an inclusive “or” and not to an exclusive “or”. For example, a condition A or B is satisfied by any one of the following: A is true (or present) and B is false (or not present); A is false (or not present) and B is true (or present); and both A and B are true (or present).

While there has been shown, described, and pointed out fundamental and novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

Any reference signs in the claims should not be construed as limiting the scope of the claims or the invention described by the subject matter claimed.

1. A circuit for managing a voltage applied to a load in view of detection of an electrical arc, said circuit comprising:
a detection circuit:
receiving a signal from said load;
detecting said electrical arc within said signal, and
generating an arc detect signal in response to a frequency said detected electrical arc;
a processing circuit:
receiving said arc detect signal generated in response to said detected electrical arc;
generating a second signal proportional to said arc detect signal;
an output circuit:
receiving said second signal; and
altering a frequency of the voltage applied to said load in response to said second signal, wherein a corresponding current applied to said load is decreased;
inhibiting generation of said proportional signal; and
wherein said altered frequency is an increase in frequency.

2. The circuit of claim 1, wherein said detection circuit comprises:
a high pass filter; and
a RC filter, said RC filter generating said arc detect signal in response to an output of said high pass filter.

3. The circuit of claim 1, wherein said processing circuit comprises:
a signal generator receiving said arc detect signal; and a control signal regulator, said regulator generating said second signal proportional to said received arc detect signal.

4. The circuit of claim 1, wherein said frequency of said voltage applied to said load is altered as a function of said frequency of said control pulses.

5. The circuit of claim 2 further comprising:
a rectifier receiving said output of said high pass filter and providing an output to said RC filter.

6. The circuit of claim 1, further comprising:
a stop-gap/blanking circuit, said stop-gap circuit inhibiting generation of said second signal.

7. A method for managing a voltage applied to a load comprising:
determining a generation of an electrical arc, said electrical arc being determined based on detecting a high frequency signal;
isolating and filtering said high frequency signal;
generating a signal having a frequency proportional to said filtered high frequency signal;
altering a frequency of said voltage in response to said signal, wherein alteration of said frequency of said voltage is a function of the frequency of the signal;
inhibiting generation of said proportional signal; and
wherein said altered frequency is an increase in frequency.

8. (canceled)

9. (canceled)

10. A protection circuit comprising:
a first converter converting a received input AC signal to a DC signal;
a second converter converting said DC signal to an AC output signal at a desired frequency;
a feedback circuit providing a signal to said second converter, said signal having a frequency proportional to a frequency of a detected arc signal, wherein said signal when applied to said second converter causes a frequency of the voltage associated with said AC output signal to be increased;
a stop-gap/blanking circuit inhibiting generation of said proportional signal; and
an arc detection circuit generating said arc detect signal in response to detection of a high frequency signal on said AC output signal.

11. (canceled)

12. (canceled)

13. The protection circuit of claim 10, wherein said arc detection circuit comprises:
a high pass filter;
a rectifier; and
a RC filter.

14. The protection circuit of claim 10 further comprising:
a DC supply generator circuit.

15. The protection circuit of claim 13, wherein said high pass filter includes a transformer.
